(19) United States
(12) Patent Application Publication
(10) Pub. No.: US 2015/0225031 A1
(43) Pub. Date: Aug. 13, 2015

(54) DISPOSABLE BICYCLE SEAT COVER

(71) Applicants: Yvonne Alvarez, New York, NY (US); Arlene Alvarez, New York, NY (US)

(72) Inventors: Yvonne Alvarez, New York, NY (US); Arlene Alvarez, New York, NY (US)

(21) Appl. No.: 14/178,821

(22) Filed: Feb. 12, 2014

(51) Int. Cl. B62J 1/20

(52) U.S. Cl. CPC B62J 1/20

(57) ABSTRACT

A disposable seat cover for covering the seat of a bicycle or similar vehicle during to use. The disposable seat cover comprises a cover body and an elastic rim. The cover body is sized and adapted to be placed over a conventional bicycle seat such that it completely covers the exterior surface thereof. The elastic rim is adapted to be stretched over the perimeter of the conventional bicycle seat and down past the bottom edge around the perimeter of the conventional bicycle seat when the cover body is placed thereon, enabling the disposable seat cover to be secured on the conventional bicycle seat. When in place, the disposable seat cover can be removed by stretching the elastic rim outwards, away from the conventional bicycle seat and lifting the cover body off of the conventional bicycle seat.

### BACKGROUND OF THE INVENTION

1. Field of the Invention

This invention relates generally to bicycle accessories and, more particularly, to a disposable, slip on cover for a bicycle seat for providing protection to a user on a bicycle from unsanitary matter present on the bicycle seat.

2. Description of the Prior Art

The use of pedal driven, single-track vehicles such as a bicycle is well known. Bicycles are typically defined as open air human powered vehicles which have two wheels attached to a frame. Other similar vehicles include human powered devices having one or more wheels (i.e. unicycles, tricycles), devices which are motor driven (i.e. motorcycles), or stationary devices which employ the pedal driving aspect for exercise purposes. One commonality throughout such riding devices is the presence of one or more seats which are exposed to a wide variety of conditions, all of which may not be particularly sanitary.

In many public areas, bicycles are available to be rented for one time or periodic use. As such, it is specifically contemplated that such bicycles (or other similar, vehicles discussed about) will be used by a plurality of different people. A problem which still exists, however, is that with some many different individuals using the same bike seat, individuals may be forced to sit on a bike seat which is soiled or otherwise not clean from a previous use. Furthermore, for such vehicles which are used outside, seats may be also wet or contain residue not just from previous use, but also from the elements. Thus, there remains a need for a bicycle seat cover which provided a disposable covering which could be securely be slipped on a bicycle seat before use. It would be helpful if such a disposable bicycle seat cover was structured to cover a bicycle seat sufficient to prevent a rider from having to contact a moisture or dirt on a seat. It would be additionally desirable for such a disposable bicycle seat cover to be constructed of a non-slip material to help prevent a rider from falling off a bicycle.

The Applicant's invention described herein provides for a disposable bicycle seat cover adapted to be slid over and secured to a bicycle seat before use. The primary component of Applicant's disposable bicycle seat cover is a base cover having an elastic rim. When in operation, the disposable bicycle seat cover enables a rider to cover the seat of a bicycle or similar vehicle during to use. As a result, many of the limitations imposed by conventional bicycle seats are removed.

### SUMMARY OF THE INVENTION

A disposable seat cover for covering the seat of a bicycle or similar vehicle during to use. The disposable seat cover comprises a cover body and an elastic rim. The cover body is sized and adapted to be placed over a conventional bicycle seat such that it completely covers the exterior surface thereof. The cover body therefore provides a means for covering the seat of a riding device. The elastic rim is adapted to be stretched over the perimeter of the conventional bicycle seat and down past the bottom edge around the perimeter of the conventional bicycle seat when the cover body is placed thereon, enabling the disposable seat cover to be secured on the conventional bicycle seat. As such, the elastic rim provides a means for securing the disposable bicycle seat cover in place on the seat of the riding device. When in place, the disposable seat cover can be removed by stretching the elastic rim outwards, away from the conventional bicycle seat and lifting the cover body off of the conventional bicycle seat.

It is an object of this invention to provide a bicycle seat cover which provides a disposable covering which could be securely be slipped on a bicycle seat before use.

It is another object of this invention to provide a disposable bicycle seat cover structured to cover a bicycle seat sufficient to prevent a rider from having to contact a moisture or dirt on a seat.

It is yet another object of this invention to provide a disposable bicycle seat cover constructed of a non-slip material to help prevent a rider from falling off a bicycle.

These and other objects will be apparent to one of skill in the art.

### BRIEF DESCRIPTION OF THE DRAWINGS

FIG. 1a is a side perspective view of a conventional bike seat.

FIG. 1b is a side perspective view of a disposable bicycle seat cover built in accordance with the present invention.

FIG. 1c is a side perspective view of a disposable bicycle seat cover built in accordance with the present invention disposed on a conventional bike seat.

### DETAILED DESCRIPTION OF THE INVENTION

Referring now to the drawings and in particular Figures la and lb, a bicycle seat assembly 10 is shown as a conventional bicycle seat 11 disposed on a seatpost 12. It is contemplated that the conventional bicycle seat 11 in accordance with the present invention may be disposed on any pedal driven or motor driven vehicle having such an open air seat, or comparable stationary devices. A disposable seat cover 15 is defined by a cover body 16 and an elastic rim 17. The cover body 16 is sized and adapted to be placed over the conventional bicycle seat 11 such that it completely covers the exterior surface thereof. The elastic rim 17 is adapted to be stretched over the perimeter of the conventional bicycle seat 11 and down past the bottom edge 13 around the perimeter of the conventional bicycle seat 11 when the cover body 16 is placed thereon, enabling the disposable seat cover 15 to be secured on the conventional bicycle seat 11.

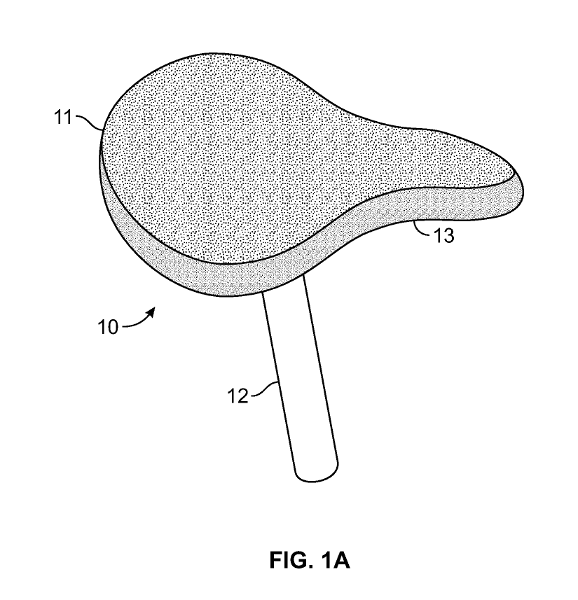

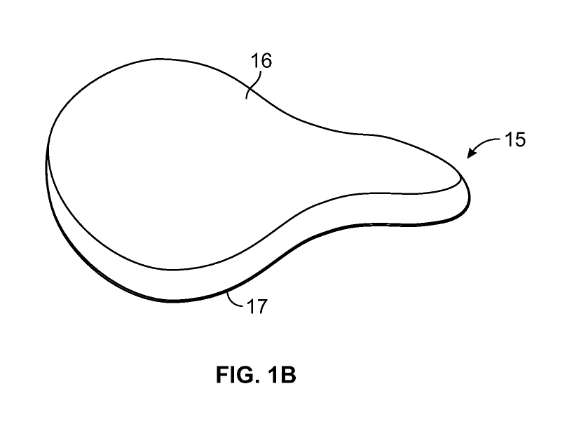

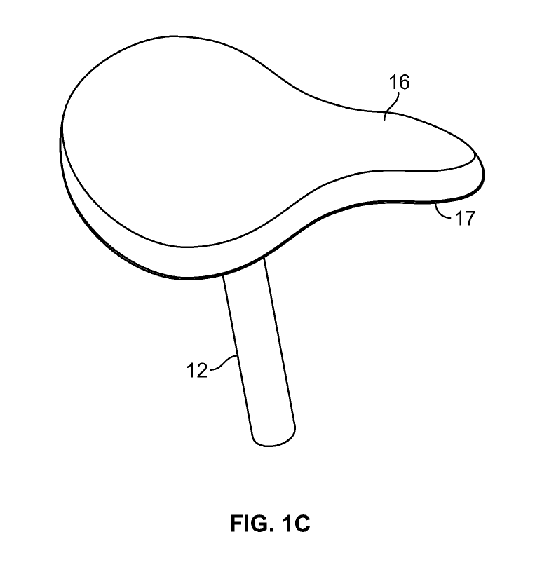

Referring now to FIG. 1c, the disposable seat cover 15 is shown secured in place over the conventional bicycle seat (not visible). The elastic rim 17 is disposed below the bottom edge (not visible) of the conventional bicycle seat, and through such action, the disposable seat cover 15 can remain in place with the cover body 16 over the surface of the conventional bicycle seat.

To remove the disposable seat cover 15 when it is disposed on the conventional bicycle seat 11, the elastic rim must be stretched outwards, away from the conventional bicycle seat 11 and then the cover body must be lifted off of the conventional bicycle seat 11. At this point, the disposable seat cover 15 may be discarded or kept for reuse.

In the preferred embodiment, the cover body 16 of the disposable seat cover 15 is constructed out of a thin plastic material having non-slip properties and the elastic rim 17 is constructed out of a rubber material.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A disposable bicycle seat cover, comprising:
a cover body adapted to cover the seat of a riding device; and
an elastic rim which is adapted to stretch around the circumference of the seat of a riding device to secure the cover body over the surface of the seat of the riding device and the disposable bicycle seat cover in place on the seat of the riding device.

2. The disposable bicycle seat cover of claim 1, wherein the cover body is constructed of a thin plastic material having non-slip properties.

3. A disposable bicycle seat cover, comprising:
a means for covering the seat of a riding device; and
a means for securing the disposable bicycle seat cover in place on the seat of the riding device.
